(19) United States
(12) Patent Application Publication
(10) Pub. No.: US 2005/0122313 A1
(43) Pub. Date: Jun. 9, 2005

(54) Versatile, configurable keyboard

(75) Inventor: Michael Ashby, Boeblingen (DE)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/985,470

(22) Filed: Nov. 10, 2004

(30) Foreign Application Priority Data
Nov. 11, 2003 (EP) 03104142.9

(51) Int. Cl. G09G 5/00

(52) U.S. Cl. 345/168

(57) ABSTRACT

A computer keyboard is provided allowing configuration of the keys in any position. The keyboard includes a sensing surface capable of sensing the position of one or multiple, simultaneous finger presses. The position of the keyboard homekeys can be defined as the most comfortable, natural position of a user's hands. The remaining keys may have their positions defined relative to the homekeys for ease of use. Also, the keyboard can automatically adjust the position of the non-homekeys based on a moving average of the actual location of the user's depression of each such key.

### FIELD OF THE INVENTION

The present invention relates in general to input devices for computers and, more particularly, to computer keyboards. Specifically, the present invention is concerned with a keyboard which is dynamically configurable and adaptable and with associated methods of configuring and adapting.

### BACKGROUND OF THE INVENTION

Existing keyboards can cause repetitive strain injuries, also known as cumulative trauma disorder and their ability to be adapted to suit the user is very limited. They often only provide a wrist rest, and a couple of legs at the back to change the desk/keyboard angle by a few degrees. Some “ergonomic” keyboards have the keys for the left and right hand in separate groups, and arranged at different angles to cause less strain for the user—but this is still a one-size-fits-all solution that can only aim to make things better for the person with an average and healthy physiological construction.

The disabled are presented with a number of challenges which other users take for granted when it comes to using computer systems. Most people take it for granted that one can walk up to any personal computer and start typing. However, there are a variety of disabilities which make it difficult or impossible for some people to use a standard keyboard. For example, a person with a handicap affecting one hand may do better if the most commonly used keys were all aligned within the range of the other hand. Meanwhile, the cognitively disabled may find that an alphabetically arranged keyboard serves them best. In any case there is not one keyboard layout that would accommodate all handicaps. Nevertheless, people without any handicap at all might do better with a keyboard specifically tailored for their individual hand size and finger movement range.

Existing keyboards have a fixed set of keys from a particular character set. If one needs other characters that are not hard-coded into the keyboard, some other, mostly less convenient and less ergonomic, technique has to be used, such as a cryptic Alt key sequence, e.g., on a computer using the common Windows™ operating system, holding down the Alt key and typing “0169” thus generating the copyright symbol, or copying and pasting the characters from the Windows™ Character Map program or similar programs.

Techniques have been described wherein a data or command input device detects and analyzes hand or finger motions of a user in a system including a TV-sensor being placed in a way that it allows an unobstructed view at the user's hand and/or fingers, and means for digitizing and processing signals from the TV-sensor. Shape, position and active motions of the user's hand and/or fingers are simultaneously detected and analyzed, whereby the motions are interpreted as respective input data or commands, said active motions comprising key hit motions that are detected by subsequent frames of the TV-sensor.

On-Screen keyboards are also known that are used by individuals who need an alternative to the physical keyboard, can use a pointing device or switch, and need an on-screen keyboard as their primary text input device. Some of these on-screen concepts use the so-called “Heads Up Display” technology, the principal objective of which is to keep the user's focus and concentration centered in one place. Thus, this concept is used to reduce the visual re-focusing and re-positioning, caused by the heads up and down motion of going from screen to keyboard to screen, and the resulting confusion it causes.

Another on-screen keyboard that can help individuals of all ages who are unable to use a physical keyboard, such as those with spinal cord injuries, amyotrophic lateral sclerosis (ALS), muscular dystrophy, and cerebral palsy, is offered by a company called WiVik. These keyboards can contain any keys, can be moved anywhere on the screen and can be any size. However, they are prefabricated and keys can only be present in predefined areas. Accordingly, keys cannot be freely adapted automatically. In addition, for users who have to do a lot of typing, on-screen keyboards are not ergonomic and do not allow fast touch typing.

Also, published U.S. Patent Application U.S. 2002/0154038 A1 discloses an interchangeable keyboard with self defining keys, where each keyboard key is marked with a self-defining indicator. A matrix of key sensing circuits for the keyboard are configured to detect this indicator when the keys are depressed and provide an output to a keyboard controller which in turn provides key signals to the keyboard's connector that is indistinguishable by a computer system from the output of a standard QWERTY keyboard. The user can swap any keys without having to make changes to the computer's operating system or any software of the computer. However, the matrix has fixed key positions and the keys cannot be freely positioned to suit the physical needs of the user, e.g., hand size, etc.

### SUMMARY OF THE INVENTION

It is therefore an object of the present invention to provide a method for configuring a data input device, especially a keyboard, that will overcome the disadvantages of the state of the art. More specifically, it is an object of the present invention to provide a keyboard which is configurable without limitation as to the placement of the keys. Moreover, a keyboard of the present invention should allow for automatic, on-the-fly re-configuration of key locations with a minimum of user effort. Finally, a keyboard of the present invention should automatically adapt to slight and gradual variations in a user's input of the defined keys.

These and other objects and advantages are achieved by the method disclosed in claim 1 and the data input device in claim 18. Advantageous embodiments of the invention are disclosed in the dependent claims.

### BRIEF DESCRIPTION OF THE DRAWINGS

Embodiments of the present invention will be described in some detail in the following specification and with reference to the following figures in which like elements are referred to using like reference numbers and in which:

FIG. 1 illustrates a possible ergonomic arrangement of the key positions of a part of a keyboard according to embodiments of the present invention for a person with a left hand of the size and shape shown;

FIG. 2 illustrates a sensing array below the sensing surface of a keyboard according to embodiments of the present invention;

FIG. 3 is a flowchart illustrating the steps of the process according to embodiments of the present invention;

FIG. 4 is a flowchart illustrating the definition of the keyboard type;

FIG. 5 is a flowchart illustrating the definition of the personalized layout of the keyboard for a user's hand size according to embodiments of the invention;

FIG. 6 is a flowchart illustrating how the optimization procedure according to embodiments of the invention can be integrated in the normal operation as a keyboard;

FIG. 7 shows the adjustment of the coordinate system relative to the rotation of a user's hand; and

FIG. 8 illustrates a special embodiment of the present invention, where real keys are stuck in an appropriate position on a sheet of plastic.

### DETAILED DESCRIPTION OF EMBODIMENTS OF THE PRESENT INVENTION

To enter data e.g. into a computer, the keyboard is the most widely used device. It allows fast, unambiguous input of digital data.

In general, the task of a keyboard is to sense the depression of keys by the operator, transmit the intended character to the computer and to produce some feedback when a key has been touched or pressed. Generally, the keyboard furthermore contains memory and a processor which perform the scanning and interpretation of the applied pressure and the transmission functions to the computer.

In the following, the word “key” can mean either a physical “real” key, a printed area, an area displayed on a touch sensitive screen, to the intended keystroke inferred from the position of the user's finger press relative to the most recently defined home key position for said finger. For the skilled worker, it will become clear from the context which of these meanings each time will apply.

Normally, such a keyboard shows fixed key positions and is constructed with only one or two dedicated switches per key.

Rather than having one switch per key in fixed positions, the keyboard according to the invention requires a surface containing a plurality of pressure sensors that are not pre-allocated to particular keys. With the inventive method, the position of individual keys can be defined at any place on the sensing surface or plane of the keyboard automatically. For example, a membrane-type, i.e., flat keyboard can be used. However, other types of keyboards, like, e.g., touch sensitive on-screen keyboards, can also be used. Such keyboards do not have fixed keys with many switches, however, there are predefined areas associated with each possible key present on the sensing surface.

The keyboard according to the invention uses a surface containing a matrix of pressure sensing points. The sensing points are close enough that pressing a finger anywhere on the sensing surface will activate one or more switches at the same time. Software implements an adaptive configuration algorithm.

It is possible that, e.g. when using a membrane keyboard, the keyboard has one sensor array which can detect pressure applied on either side of the keyboard which makes it possible to have a double sided keyboard, which would also require a sensor to detect which side was facing up, and hence which side the user is using.

At least on one side of the membrane keyboard according to the invention, there are no fixed alphabetic key positions. It may, however, be possible that just two adjustable tactile positioners for the index finger of each hand are present, or that one side of the keyboard carries some non-touch-type keys, like, e.g., function keys (F1-F12). However, these are not necessary for carrying out the present invention. Since there are no predefined areas and, accordingly, no fixed key positions printed on the membrane, the key positions can be freely defined.

In order to carry out this defining step which will be described in more detail later, the user first of all will have to select, in a so called configuration mode, for which country the keyboard will be used, i.e., whether, e.g., a standard German keyboard or an international keyboard is needed, these keyboards differing in the arrangement of special keys, for example the “Ö” or “:” keys. In addition, the user will also select the keyboard layout, i.e., whether the keyboard has, e.g., a “QWERTY” or a “Dvorak” layout. Furthermore, the user will have to specify the number N of typing fingers, i.e., the number of fingers that will be used for touch-typing by the user. Normally, N will be 10. However, in the case of a user having x paralyzed, missing or weak fingers, N will be 10-x.

Defining the user's personalized layout can be as simple as pressing the home key fingers down and letting the keyboard predict all the other keys, or the user can define more key rows/keys. This will be explained in more detail later.

Having selected the keyboard type, e.g., QWERTY or the like, the user now can, after having left the configuration mode, in the next step, place all his/her N typing fingers in a comfortable position on the keyboard area, i.e., at any angle to each other and any distance apart, restricted only by the keyboard area available, and presses down all the typing fingers and thumbs onto the keyboard's sensing surface to thus define the positions of the touch-typing home keys and the space bar (or two space keys). On an international keyboard, these will be the keys ASDFJK:, on a standard German keyboard ASDFJKLÖ. The processor associated with the keyboard will scan the pressure, interpret these keystroke events as defining the home keys, and store these positions in a memory. Software will detect the difference between the case that all fingers are pressed on the keyboard's sensing surface at the same time and the case that only one, two or three keys are pressed, thereby differentiating between a defining step and normal touch-typing.

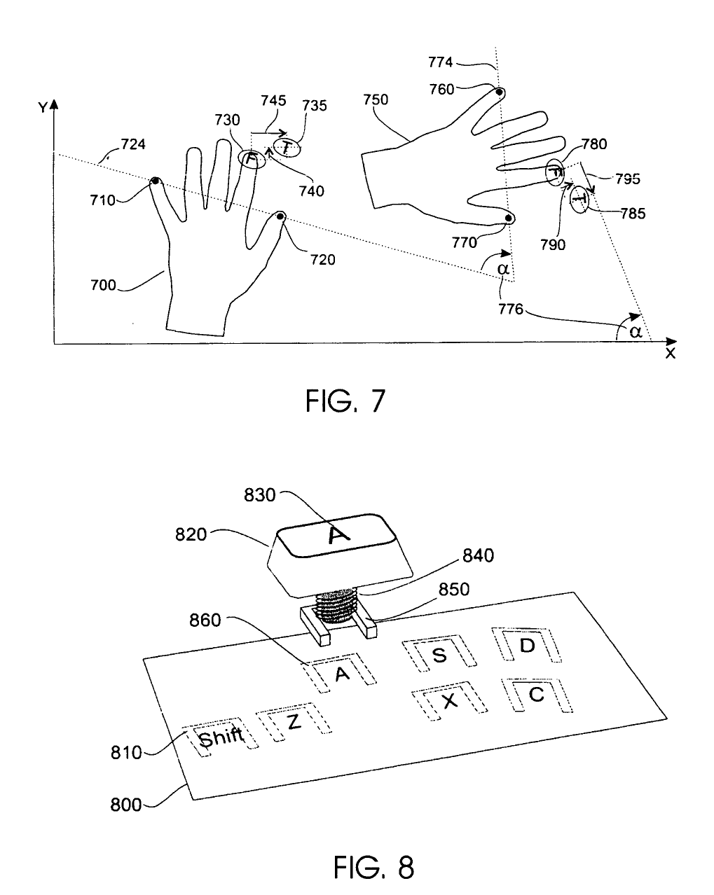

From the positions thus defined as home keys, software will predict the locations of all the other keys on the sensing surface starting from the known arrangement of keys of “normal” keyboards. For example, when predicting the key for the letter “X”, the software starts from the prerequisite that on “normal” keyboards the letter “X” lies somewhat below and to the right of the key representing the letter “S”. The exact location of the other keys, however, will depend on the angle of the user's hand relative to the keyboard. This will be explained in more detail with respect to FIG. 7.

Next, positions will be optimized or adapted in a so called “optimization mode”.

This optimization can, e.g., be carried out by calculating a moving average of the last n presses of each key, i.e., the assumed center of a key, as shown in the following table. The moving average may also be weighted to make recent keystrokes contribute more to the moving average than less recent keystrokes. The moving average coordinates for each key constitute the so called “predicted” or “expected” position of the key.

TABLE 1
Optimization of the predicted/expected position of keys by calculating
a moving average of the last n presses of a key, where (X₁ₕ, Y₁ₕ)
are the coordinates of the most recent press of key h and (Xₙₕ, Yₙₕ)
are the coordinates of the press n presses ago and Xₕ and Yₕ is the
moving average, i.e., the currently predicted center of key h.

| | | | Expected position |
|---|---|---|---|
| | Relative to | Position relative to that | (moving average of last |
| Key | home key | finger's home key | n presses) |
| Z | A | X_{1z}, Y_{1z} . . . X_{nz}, Y_{nz} | (X_{z}, Y_{z}) |
| X | S | X₁ₓ, Y₁ₓ . . . Xₙₓ, Yₙₓ | (Xₓ, Yₓ) |
| C | D | X_{1c}, Y_{1c} . . . X_{nc}, Y_{nc} | (X_{c}, Y_{c}) |
| . | . | . | . |
| . | . | . | . |
| . | . | . | . |

Adaptive software algorithms will refine the expected locations to match the real positions where the user's fingers press the “invisible” keys.

If the optimization mode is deactivated, the predicted positions are stored in memory and are not updated in future—thus fixing the layout to suit the user.

Having defined the key positions in this way, the user can touch type on the “invisible” keys of the keyboard. The processor will then use an adaptive algorithm to interpret which keystroke is intended by finger-presses that are away from the home keys. It has to be mentioned that only the home keys are absolute positions, and all other keys are defined relative to the home key for the appropriate finger and the angle of rotation of the hand, e.g., according to a base line from fingers 1-5 (cf. FIG. 7).

Used in this way, the keyboard according to the invention is a flat ergonomic keyboard that can be used by many different users.

It has to be mentioned that the user can at any time press all his/her typing fingers again on the sensing surface of the keyboard to redefine the home key positions.

Any activity detected outside the currently defined keyboard area causes a change from keyboard mode to mouse mode, in which the detected movements on the keyboard are interpreted as mouse movements and mouse clicks. In mouse mode, the whole keyboard sensor area can be used just like those finger-mouse-pads that are common on notebook computers.

After using the keyboard in mouse mode, pressing all N typing fingers on the sensing surface of the keyboard redefines the positions of the home keys and all other keys that are defined relative to the home keys according to the configuration and the expected key positions. Thus, the user switches back into keyboard mode.

A memory is used to store configuration data, the current mode, last known home positions, user profile, expected key positions of non-home keys relative to the home keys, etc., to interpret actions on the pressure sensor array area. Having interpreted the actions as typing, mouse movements, mouse clicks, or mode changes, the processor transmits any appropriate information to the PC via PS2, serial, USB, IR, wireless, or any other keyboard and mouse connection technique.

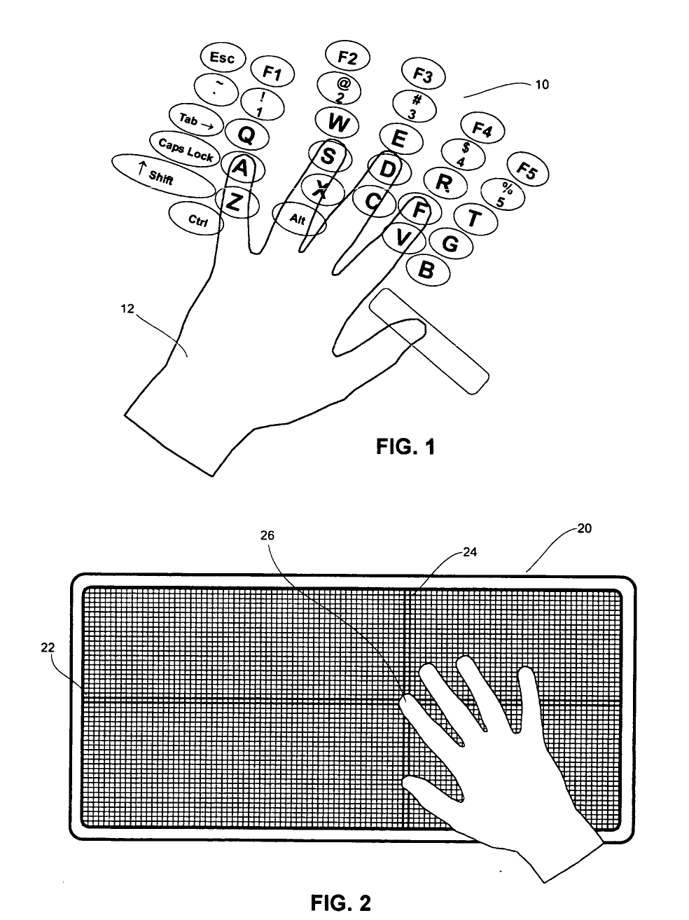

FIG. 1 shows the left half of the keyboard 10, and illustrates a possible ergonomic arrangement of the key positions for a person's left hand 12. The hand-shaped shadow only appears on this diagram to illustrate the hand size and angle that such an arrangement would suit.

In a preferred embodiment of the present invention, the ideal layout is printed on two plastic sheets—one per hand—to which real keys could be attached in the positions and angular orientations printed (cf. FIG. 8). When the keys are pressed, they transmit pressure from the finger down to the pressure sensing surface, where they will activate a plurality of sensors. These two moveable real key units (for left and right hand), can be moved and change angle, being held in place, e.g., by built-in magnets or other releaseable securing mechanism. Pressing N keys lets the keyboard know where the key units are positioned.

In a special embodiment, these keys may also have a special code on the underside that can be sensed and recognized when pressed against the sensing surface.

Thus, the actual key positions could be
1. Invisible, i.e., not marked, defined relative to the home positions ASDF;
2. Printed on the flat surface, with some texture or edges that make it easy to find the home positions by touch; or
3. Real keys units that are either fixed or moveable, and apply pressure to the underlying sensing array when pushed down by the user. However, in case a double sided keyboard with real keys is used, it may become impractical to turn the keyboard over and type on the other side.

FIG. 2 illustrates a kind of pressure sensing array 20 of the keyboard that can sense the positions where pressure is applied to it. The array 20 may be implemented using a grid of horizontal 22 and vertical 24 sense wires. The density of the sensors guarantees that any finger pressed anywhere on the sensing array will be detected, i.e., finger press 26, will activate one or more sensing points. The detection of multiple, simultaneous finger or key presses can also be detected optically, e.g., by light beams in front of a display, or by proximity sensors.

In order to provide an ergonomically optimized, personalized keyboard, the user can find the most comfortable home positions for his/her hand, do some touch typing and let the keyboard, via a respective front-end program on the computer, calculate the ergonomically optimum key positions for that person and print out the optimum positions on a plastic template. The user may then stick the preprinted real keys, e.g. supplied with the keyboard, at the optimal positions. These positions can be stored in the keyboard's nonvolatile memory. Furthermore, any activity in non-key areas can be treated as mousepad activity.

In case a person wants an ergonomic German keyboard but also would like to have access to the special characters for, e.g., French and Spanish, he/she can simply optimize and then attach the keys for a German keyboard, and then attach the additional special French and Spanish keys in any available areas on the sensor area.

In the embodiment which does not have real keys attached, during the course of the day it is probably natural that the preferred homekey positions will change as the user progresses from being well rested in the morning to being more physically fatigued by the end of the day. Even though the user can always push all 10 fingers on the keyboard at the same time to redefine new homekey positions, the software should preferably be flexible enough to adjust to the home positions drifting slightly over time, e.g., by calculating a moving average of the center of the finger for the last n presses of each invisible key.

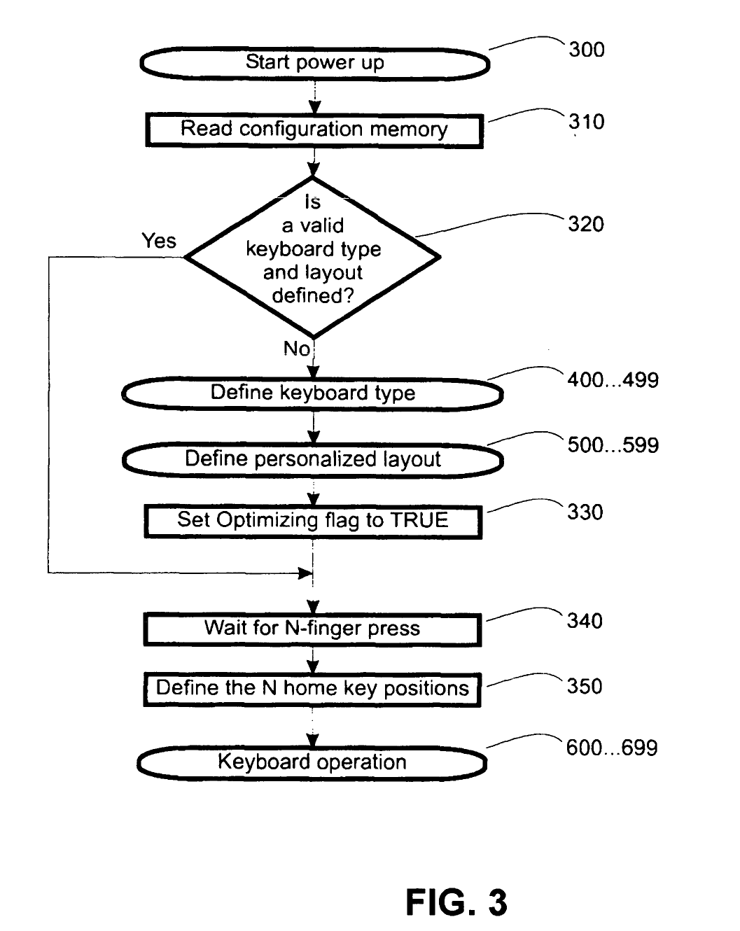

FIG. 3 shows a flowchart indicating the steps of the process according to the present invention.

On power up (Step 300) the configuration memory of the keyboard is read (Step 310) and it will be decided whether a valid keyboard type and layout is already defined. (Step 320). If so, the program will jump to Step 340, where the system waits for the user to press his/her fingers on the sensing surface of the keyboard. By this N-finger press, the user defines the position of the N home keys (Step 350). The chosen position of the home keys will as well be stored in memory.

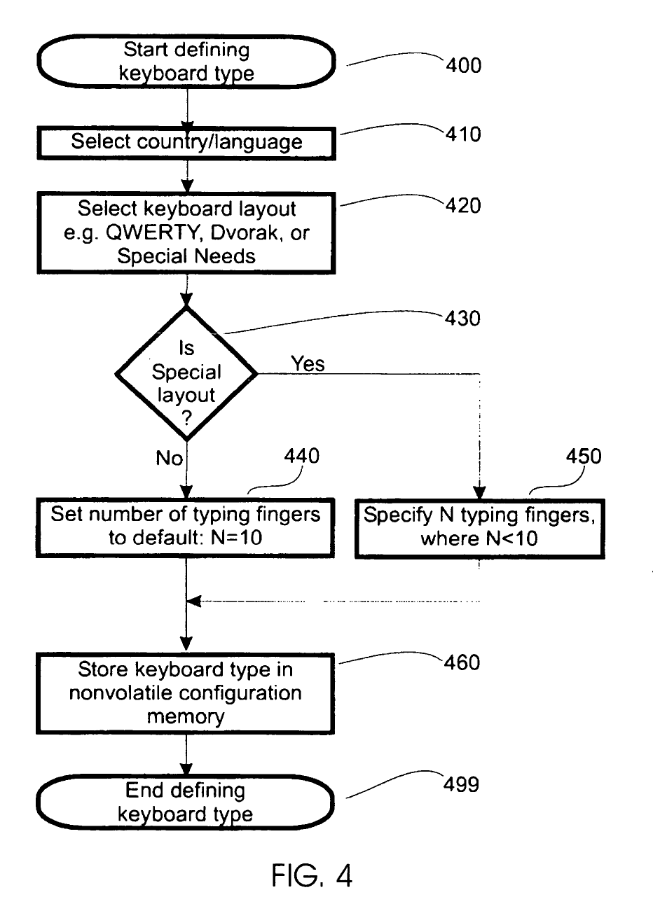

In case no valid keyboard type and/or layout is defined, which will be the case when the keyboard is used for the first time, the user will have to define a keyboard type first. The respective steps are shown in FIG. 4. When starting defining the keyboard type (Step 400), the user first has to select, which country/language he would like to use (Step 410). Next, in a step 420, he will have to decide which keyboard layout, e.g., QWERTY, Dvorak, etc., he would like to use (Step 420). In the next step 430, it is decided whether a special layout is necessary, e.g., for a person only having the use of less than 10 fingers. In case no special layout is required, the number of typing fingers is set to the default value of 10 (step 440). Otherwise, the number of typing fingers (<10) will have to be defined by the user in step 450. Subsequently, the keyboard type and layout will be stored in the nonvolatile configuration memory (Step 460) and the definition mode is ended (Step 499).

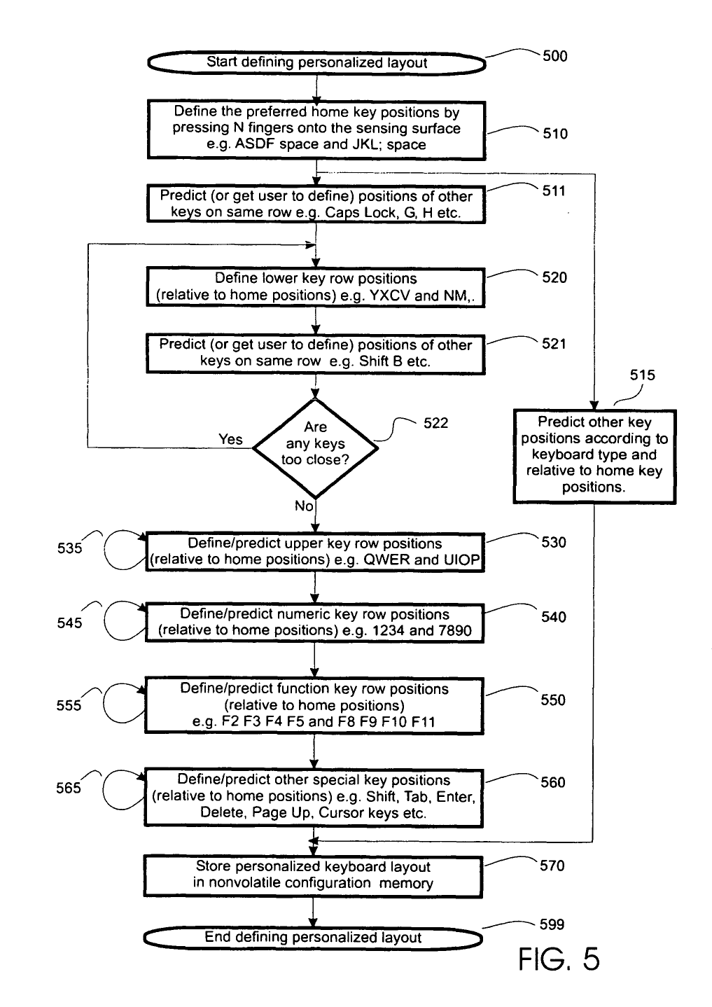

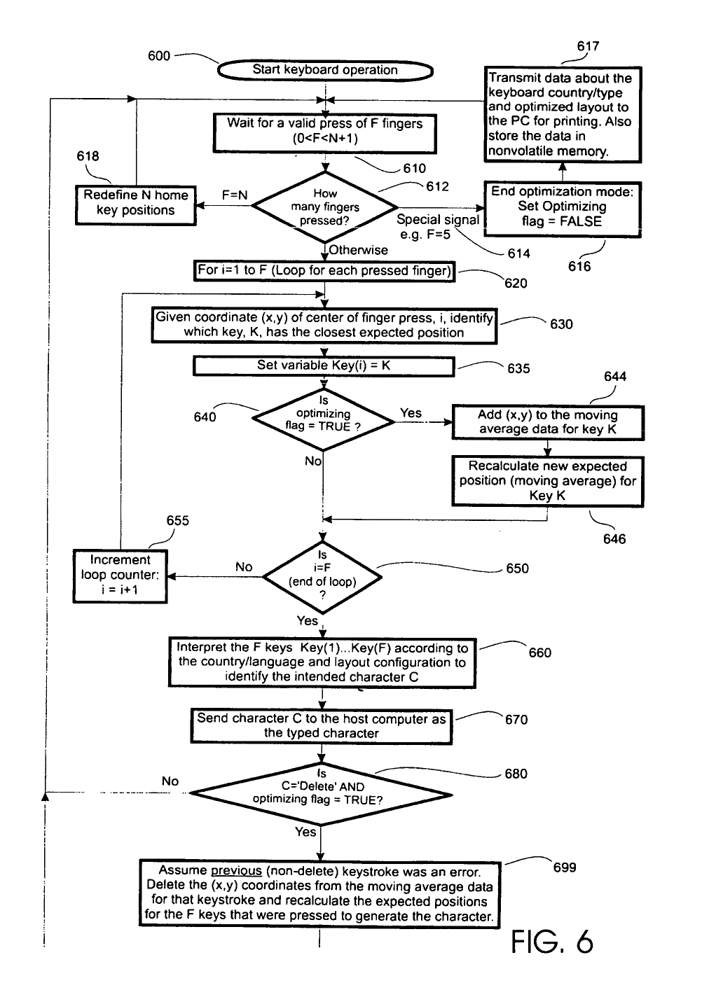

Next, the personalized layout will have to be defined by the user (cf. FIG. 5). On starting the definition of the personalized layout (Step 500), the preferred home key positions of the user are defined by pressing all N fingers previously defined onto the sensing surface of the keyboard (Step 510). With the stored values of the home key positions, software will, in a so called prediction mode (Step 515) predict the locations of all other keys on the sensing surface of the keyboard according to keyboard type and relative to the home key positions. All positions will be optimized or adapted during keyboard operation in a so called optimization mode (which will be described in more detail later on with respect to FIG. 6) over time by calculating a moving average, which will make the prediction of ideal the ideal key positions better and better.

It is however possible to predict or get the user to define positions of other keys row by row. For example, an LCD display in the keyboard may prompt the user to “Now move your hand down to the lower row of keys and press them all down at the same time”, or the like. Accordingly, positions of other keys on the same row as the home keys will be predicted or defined by the user first (Step 511). Subsequently, the lower key row positions will be predicted or defined (Step 520). Again, it has to be mentioned that all other keys are predicted or defined relative to the positions of the home keys. Next, in step 521, all other keys on the same row, like, e.g., Shift-B or the like, will be predicted or defined.

In step 522 it is decided whether any keys are too close to other keys. If yes, steps 520 and 521 are repeated until at last no keys are too close to one another. Then the upper key row positions are predicted or defined relative to the position of the home keys (Step 530). Finally, the numeric key row positions (Step 540), the function key row positions (Step 550) and other special key positions (Step 560) are predicted or defined in the same way. The personalized keyboard layout thus defined is stored in nonvolatile configuration memory (Step 570) and the definition mode is ended (Step 599).

Each prediction or definition step may be repeated (Steps 535, 545, 555 and 565) until no keys are too close to any already defined key position.

After the definition mode for the personalized layout has been left, an optimizing flag is set to TRUE (Step 330). This is the desired default behavior that optimizing mode is activated after the user has defined a (new) configuration for the (new) keyboard.

Finally, keyboard operation can be started (cf. FIG. 6, Step 600). In step 610 the system is waiting for a valid press (i.e., standard key scanning must filter out electrical noise caused by the switch contacts, commonly known as “debouncing” a switch) of F fingers of the user, whereby 0<F<N+1. If the user presses one or more fingers on the sensing surface of the keyboard, the system will decide (Step 612) the number of fingers used at a time. In case F Is equal to N, i.e., the number of typing fingers defined previously, it will redefine the home key positions (Step 618). In case the number of fingers equals a predefined special signal, e.g., F=5 (Step 614), the optimization mode is ended. The optimization flag is set to FALSE (Step 616). The data about the keyboard country/type and the current layout is stored in non-volatile memory, thus making the knowledge about the user's hand size optimized positions available in the future—even after rebooting the computer, transmitted to the computer for printing or the like (Step 617) and a new valid press of F fingers can be initiated. The print out could be used as a layout sheet on top of the sensing surface or to stick on real keys. In this respect, reference is made to FIG. 8. The PC is used to print a layout on sheet of plastic 800, where the ideal position of each key is marked (e.g., 810 to 860), so that the user can stick a real key 820 with its associated character 830 printed on the top, having a spring 840 or equivalent mechanism and a base 850, which has a sticky underside that can be revealed by removing a protective paper covering, thus allowing the real key, etc. to be stuck in the appropriate position 860 (of course, other releasable securing mechanisms could be used to maintain the keys in position, such as magnets, etc.). Another possibility could be to send the data to a factory for manufacturing customized key units.

In case the number of fingers pressed on the sensing surface of the keyboard is different from N and the special recognizable signal, the system will perform a loop for each finger pressed (the loop consisting of all boxes in the number range from 620 to 655). First, the coordinates (x,y) of the center of each finger press i is detected, and it is identified which key K has the closest expected position, e.g., where K=(with the minimum distance from (x,y) to (X₍,X₍) as in Table 1 (Step 630). Subsequently, variable key(i) is set to K, i.e., the identity of the key K pressed by finger i is stored in memory, for example, an array variable as shown in Step 635. If in step 640 it is detected that the optimizing flag is set to TRUE (ct. Fig. 3, Step 330), indicating that the system is in optimization mode, the coordinates are added to the moving average data for key K (cf. Table 1). Then, in step 646, the new expected position (moving average) for key K is recalculated and the program proceeds to step 650. In case the optimizing flag is not set to TRUE, it will be detected whether all F finger presses have been processed (Step 650), in which case the loop 620 to 655 is ended and the system proceeds to step 660. If i is not equal to F, a loop counter is incremented by 1 (Step 655) and the loop is continued at Step 630 to process finger press i.

After the loop has been ended, the F keys pressed (Key(1) . . . Key(F)), are interpreted according to the country/language and layout configuration to identify the character C intended by the user (Step 660). Subsequently, the character C is sent to the host computer as the typed character (Step 670).

In case C is the “Delete” key and the optimizing flag is set to TRUE, the system will assume that the previous (non delete) keystroke was an error. The coordinates in the moving average data for that keystroke will be deleted and the expected positions for the F keys that were pressed to generate the character are recalculated (Step 699). Then the program returns to step 610, waiting for another valid press of F fingers. The same applies in case character C is not the “Delete” key and the optimizing flag is not set to TRUE in step 680.

FIG. 7 explains the need to adjust the coordinate system relative to a possible rotation of the user's hand(s). It shows that for hand 700 the vector from the center of the home key “F” (730) to the center of the key “T” (735) may appear to be a simple horizontal and vertical offset. Note that “T” is defined relative to “F” because it is pressed with the same finger. When the same hand 700 is in position 750, it is clear that the relative coordinates must also be rotated by the angle “(776), as defined by the intersection of the line 724 passing through the home key positions for fingers 710, 720 and the line 774 passing through the new home key positions for fingers 760 and 770. What were vertical and horizontal vectors 740 and 745 within the keyboard's overall X and Y coordinate system, must be rotated by” to get the vector components 790 and 795 which, added together, define the offset of key 785 relative to key 780 for hand position 750.

By, e.g., tapping a finger on a non-key area on the sensing surface of the keyboard, the user may switch to mouse mode where all detected movements on the sensing surface of the keyboard will be interpreted as mouse movements or mouse clicks. By again pressing all N typing fingers on the sensing surface of the keyboard, the user can return to normal touch-typing.

The present invention is not specific with respect to the sensor technology used. It could equally be applied to Web Pad or Tablet style computers that have no keyboard. Simply by placing the Tablet on a table, and then pressing the ten typing fingers onto the touch-sensitive screen, the computer can immediately interpret any following presses as keystrokes, and if preferred, superimpose the images of all the key positions that the computer infers from the defined home keys.

Since membrane keyboards tend to be thin, it may be necessary or desirable to provide different physical manifestations, such as having an ergonomically adjustable base on which the reversible sensing membrane rests. Alternatively some mechanism may allow it to roll out of a Web-Pad computer to convert it into a Notebook computer or the keyboard can consist of one sensor array per hand—allowing greater body posture variety, and allowing it to be folded into a small space for storage or transportation.

As disclosed above, the keyboard according to embodiments of the present invention can be used by people with some missing fingers or a reduced ability to move their fingers. Any special variations can be stored in the keyboard's nonvolatile memory, so that keyboard-challenged people use the standard version and do not require an expensive version. Some obvious special variations include: N-finger typing for people with x weak or missing fingers, i.e., N=10-x, and reduced distance key rows for people who want to minimize finger movement. The keyboard can also interpret chording keystrokes, where multiple keys are pressed down at once, so that even one-handed people could use it to type quickly.

The meaning of a keyboard's function keys (F1-F12) can be redefined by each application program. Some keyboards have extra keys defined for starting programs, adjusting the volume, checking email etc. A keyboard according to embodiments of the present invention can support a very large number of user-defined keys, where one key press either results in an entire user-defined string of characters being sent to the active application, or a special program (with access to the system settings) interprets such “user-function” keys and performs the associated user-defined actions (things like adjusting the PC's loudspeaker volume cannot normally be achieved by sending a string of keystrokes to the current application).

The present invention has been explained in some detail be describing one or more exemplary embodiments. However, it is to be understood that the scope of the present invention is not restricted to the range of the above-described embodiments. Those skilled in the relevant arts will readily recognize that various changes or modifications may be made to the described embodiments without departing from the scope and spirit of the present invention.

1. A method for configuring a computer keyboard, comprising:
defining on a sensing surface of the keyboard a set of homekey positions for a user; and
defining on the sensing surface a set of non-homekey positions comprising positions of the remaining keys of the keyboard, such non-homekey positions being calculated and located relative to the homekey positions.

2. The method of claim 1 wherein defining the homekey positions comprises:
placing the user's hands in a preferred position for said user on said sensing surface;
pressing all of said user's typing fingers on said sensing surface;
detecting a location of each of said user's typing fingers, and;
defining said set of homekey locations as corresponding to said detected locations of said user's typing fingers.

3. The method of claim 2 wherein said keyboard is a membrane-type keyboard.

4. The method of claim 2 wherein said keyboard is an on-screen keyboard.

5. The method of claim 2, wherein said sensing surface comprises a matrix of pressure sensing points and pressing a user's finger on said sensing surface activates one or more pressure sensing point at the same time.

6. The method of claim 5 wherein said matrix of pressure sensing points is able to detect pressure applied from either side of said keyboard.

7. The method of claim 6 wherein one side of the keyboard carries fixed key positions indicated on said sensing surface.

8. The method of claim 6 wherein one side of the keyboard shows no fixed alphabetic key positions on said sensing surface.

9. The method of claim 2 wherein defining the non-home key positions comprises:
detecting typing by the user on areas other than said defined homekey positions;
calculating ergonomically optimum non-homekey positions for said user; and
redefining said non-homekey positions to be said calculated optimum positions.

10. The method of claim 9 wherein said calculation is done by defining a moving average of a position of a last n presses of each key, where n is a predefined integer.

11. The method of claim 2 further comprising, prior to defining said homekey positions, selecting, by a user, a keyboard country or language, a keyboard layout type and a number N of typing fingers to be utilized by a user.

12. The method of claim 2 wherein said step of defining the homekey positions can be repeated by the user at any time to redefine said homekey positions.

13. The method of claim 2 wherein pressure activity in non-key areas of said sensing surface is treated as mouse activity.

14. A computer keyboard comprising:
a sensing surface whereon a position of multiple, simultaneous finger or key presses is detectable;
a homekey definition unit for defining anywhere on said sensing surface a set of homekey positions for a user as requested by said user, and;
a key definition unit for defining on said sensing surface a set of non-homekey positions comprising positions of the remaining keys of the keyboard, such non-homekey positions being calculated and located relative to the homekey positions.

15. The keyboard of claim 14 wherein:
in response to detecting all of said user's typing fingers simultaneously on said sensing surface, said sensing surface detects a location of each said finger, and;
said homekey definition unit defines said homekey positions as said detected locations of said fingers.

16. The keyboard of claim 15 wherein said sensing surface comprises a membrane-type keyboard.

17. The keyboard of claim 15 wherein said sensing surface comprises an on-screen keyboard.

18. The keyboard of claim 15 wherein said sensing surface has a matrix of pressure sensing points.

19. The keyboard of claim 18 wherein said matrix of pressure sensing points is able to detect pressure applied from either side of said keyboard.

20. The keyboard of claim 14 wherein said key definition unit, in response to detection by said sensing surface of typing by the user on areas other than said defined homekey positions, calculates the ergonomically optimum non-homekey positions for said user and redefines said non-homekey positions to be said calculated optimum positions.

21. The keyboard of claim 20 wherein said calculating comprises defining a moving average of a position of a last n presses of each non-homekey key, where n is a predefined integer.
